(19) United States
(12) Patent Application Publication
(10) Pub. No.: US 2013/0273242 A1
(43) Pub. Date: Oct. 17, 2013

(54) Optical Elements on Textured Surfaces

(71) Applicant: SVAYA NANOTECHNOLOGIES, INC., Sunnyvale, CA (US)

(72) Inventors: Kevin Krogman, Santa Clara, CA (US); Thomas Hood, Portola Valley, CA (US); Siglinde Schmid, San Jose, CA (US); Benjamin Wang, Mountain View, CA (US)

(73) Assignee: Svaya Nanotechnologies, Inc., Sunnyvale, CA (US)

(21) Appl. No.: 13/861,368

(22) Filed: Apr. 11, 2013

Related U.S. Application Data
(60) Provisional application No. 61/623,555, filed on Apr. 12, 2012.

(51) Int. Cl. G02B 3/08

(52) U.S. Cl. CPC G02B 3/08
USPC 427/164; 427/162

(57) ABSTRACT

The invention provides optical elements having a substrate with a textured surface, and a coating disposed on the textured surface. The coating is a multi-layer optical coating that provides desirable optical properties for the optical element. The coating is conformally disposed on the textured surface of the substrate. The invention also provides methods for making and methods for using such optical elements.

### CROSS-REFERENCE TO RELATED APPLICATIONS

This application claims priority to U.S. Provisional Patent Application No. 61/623,555, filed Apr. 12, 2012, the contents of which are incorporated herein by reference.

### INTRODUCTION

Fresnel lenses are inexpensive optical focusing devices that take advantage of light diffraction. The ridged surface of the Fresnel element diverts light towards a small focal spot. They are widely used in lighthouses, automotive lighting, concentrating photovoltaic systems, as magnifying glasses and for inexpensive reading glasses.

To date it has been extremely challenging to coat the textured side both with vacuum deposition and traditional wet coating. Traditional wet coating does not provide the needed uniformity, especially in the grooved surface where surface tension can cause pooling or accumulation. Other deposition techniques have challenges due to line-of-sight issues (PVD, sputtering and other vacuum techniques) or material compatibility (PMMA melts at about 110° C.). Challenges typically associated with scaling vacuum techniques are well known.

US 20120082831 discloses layer-by-layer (LbL) spray deposition of nanoparticles and polyelectrolytes onto surfaces.

### SUMMARY

In an aspect, there is provided a method for forming an optical element comprising bilayers, the method comprising step(s): (a) alternately spraying polyelectrolyte and nanoparticle solutions onto a textured surface of a substrate, thereby depositing on the surface corresponding polyelectrolytes and nanoparticles and forming on the surface, in a layer-by-layer fashion, a plurality of nanoporous bilayers comprising polyelectrolyte and nanoparticle layers, wherein the polyelectrolyte and nanoparticle solutions each have a pH above 9.5.

In embodiments:

the average thickness of each bilayer is less than the average diameter of the nanoparticles;

the average thickness of each bilayer is in the range of 75-87% of the average diameter of the nanoparticles;

the pH of the nanoparticle solution is above 10.7;

the method further comprises: (b) spraying a rinse solution onto the surface after spraying each polyelectrolyte solution and after spraying each nanoparticle solution;

step (a) further comprises spraying a rinse solution onto the surface after spraying each polyelectrolyte solution and after spraying each nanoparticle solution, wherein the polyelectrolyte solution, the nanoparticle solution, and the rinse solution each comprise salts sufficient to ensure that the thickness of the plurality of nanoporous bilayers does not vary by more than a factor of two over the substrate;

step (a) further comprises spraying a rinse solution onto the surface after spraying each polyelectrolyte solution and after spraying each nanoparticle solution, wherein the average thickness of each bilayer is in the range of 75-87% of the average diameter of the nanoparticles;

the substrate comprises a smooth surface opposite the textured surface, and wherein the spraying is only on the textured surface such that the plurality of nanoporous bilayers is formed only on the textured surface;

the plurality of nanoporous bilayers comprises at least 5 bilayers;

the plurality of nanoporous bilayers comprises at least 5 bilayers; the substrate comprises a smooth surface opposite the textured surface; and the spraying is only on the textured surface such that the plurality of nanoporous bilayers is formed only on the textured surface;

the nanoparticle solution comprises a plurality of different nanoparticle solutions comprising corresponding different nanoparticles, such that the bilayers comprise a plurality of corresponding different nanoparticle layers;

the ridges of a Fresnel lens provide the textured surface;

ridges of a Fresnel lens provide the textured surface, and wherein the thickness of the plurality of nanoporous bilayers does not vary by more than a factor of two over the substrate;

the nanoparticles have an average diameter less than 50 nm;

the substrate is maintained below 40° C. during and immediately prior to the spraying;

the method further comprises: (b) spraying a rinse solution onto the surface after spraying each polyelectrolyte solution and after spraying each nanoparticle solution, wherein ridges of a Fresnel lens provide the textured surface;

step (a) further comprises spraying a rinse solution onto the surface after spraying each polyelectrolyte solution and after spraying each nanoparticle solution, wherein the nanoparticle, polyelectrolyte, and rinse solutions comprise salts sufficient to ensure that the thickness of the plurality of nanoporous bilayers does not vary by more than a factor of two over the substrate, and wherein the salts alter the zeta potential of the nanoparticles sufficiently to ensure that the average thickness of each bilayer is in the range of 75-87% of the average diameter of the nanoparticles;

the plurality of nanoporous bilayers causes substantially zero scattering of light incident on the substrate;

at least one of the polyelectrolyte and nanoparticle solutions comprise a nitrogen base-based counterion; and

each spraying has a duration of 10-30 seconds.

In one aspect, the invention provides an optical element comprising: (a) a substrate comprising a textured surface; and (b) a film comprising a plurality of nanoporous bilayers, each bilayer comprising a polyelectrolyte and nanoparticles, wherein the film is directly on, and conformal to the textured surface.

In various embodiments:

ridges of a Fresnel lens provide the textured surface,

the average thickness of each bilayer is less than the average diameter of the nanoparticles, particularly wherein the average thickness of each bilayer is in the range of 75-87% of the average diameter of the nanoparticles,

the thickness of the film does not vary by more than a factor of two over the substrate,

the nanoparticles have an average diameter less than 50 nm,

the film is anti-reflective, is a Bragg reflector, or is an optical dichroic mirror,

the film is a multilayer optical film,

the film has a refractive index (RI) lower than 1.4,

the film has an optical thickness of between 50 nm and 600 nm,

the film is self-adherent to the substrate,

the substrate is made of or comprises an optically clear material,

the film has a haze less than 0.5%,

the substrate is greater than 100 cm² in area,

an adhesion promoting block copolymer is not present between the film and the substrate, and/or

the substrate and film are configured to reduce (e.g. by at least 4%) the reflection of incident electromagnetic energy at a selected wavelength by the textured surface.

In another aspect, there is provided a method of making a subject optical element, comprising the step of depositing the film on the substrate by spray LbL deposition.

In various embodiments:

the substrate is maintained below 40° C. during and immediately prior to the deposition, and/or

the spray LBL comprises a plurality of deposition and rinse steps employing corresponding deposition and rinse solutions, wherein the deposition and rinse solutions comprise salts sufficient to ensure that the thickness of the film does not vary by more than a factor of two over the substrate, such as wherein the salts alter the zeta potential of the nanoparticles sufficiently to ensure that the average thickness of each bilayer is in the range of 75-87% of the average diameter of the nanoparticles.

In a further aspect, there is provided a method of using a subject optical element, comprising the step of integrating the optical element into a concentrating solar energy production system.

The invention includes all combinations and subcombinations of particular-recited embodiments as if each had been separately set forth. For examples, the various recited film thicknesses and the various recited nanoparticle sizes are understood to be disclosed in their alternative combinations (e.g. the average thickness of each bilayer is in the range of 75-87% of the average diameter of the nanoparticles and the nanoparticles have an average diameter less than 50 nm) and a range expressed as 1, 2, or 3 to 10, 20 or 30 units, is shorthand for 1-10, 1-20, 1-30, 2-10, 2-20, 2-30, 3-10, 3-20 and 3-30 units.

### DETAILED DESCRIPTION OF PARTICULAR EMBODIMENTS

Unless otherwise indicated, the disclosure is not limited to specific procedures, materials, or the like, as such may vary. It is also to be understood that the terminology used herein is for the purpose of describing particular embodiments only and is not intended to be limiting.

As used in the specification and the appended claims, the singular forms “a,” “an,” and the include plural referents unless the context clearly dictates otherwise. Thus, for example, reference to “a reactive species” includes not only a single reactive species but also a combination or mixture of two or more different reactive species.

In one aspect, then, the inventive optical elements comprise a substrate with a film disposed thereon, wherein the substrate comprises a textured surface and wherein the film is conformally disposed on the textured surface.

The subject substrates generally have a width and length that are both significantly greater than the substrate thickness. For example, the width and length of a substrate are independently selected and are each at least about 2, or 5, or 10, or 100 times greater than the substrate thickness. In some embodiments, the substrate thickness is typically in the range of 1, 10 or 100 um to 0.1, 1 or 10 mm, and often less than or equal to 1 cm, 5 mm, 1 mm, 0.75 mm, 0.5 mm, 0.25 mm, or 0.1 mm. In some embodiments, the substrate width and length are independently selected from values of values of greater or equal to 1, 5, 10, 25, 50, 75, or 100 cm. In some embodiments, the substrate is provided as a roll of material, such that the length is significantly greater than 1 meter (e.g., 10 meters, 100 meters, etc.). The area of the substrate used in the coating methods described herein may be any suitable area for the given application. For example, the area may be greater than 100 cm², or greater than 1000 cm² particularly when the substrate is provided as a roll of material.

The subject substrates have two opposing surfaces, wherein at least one of the surfaces is textured. In some embodiments only one surface is textured and the other surface is smooth. In other embodiments both surfaces are textured. A surface that is “textured” (as opposed to “smooth”) contains an array of lens elements that direct light entering or leaving the substrate. In some embodiments the lens elements combine to focus light passing through the textured surface.

For example, a subject substrate has a smooth surface and a textured surface, wherein the textured surface is in the form of the ridges of a Fresnel lens. The Fresnel lens surface comprises a plurality (i.e., an array) of lens element surfaces that are flat and are angled away from parallel to the smooth surface. The angle of the lens element surfaces is selected based on the intended application, and may be in the range of 10-80 degrees away from parallel. The angle of each lens element may be independently selected - i.e., the angle of a lens element may be a function of position on the substrate. In other embodiments, the angles of the lens elements are substantially constant over the entire substrate.

The size of the lens elements in a textured surface may be selected as suitable for the intended application. For example, the depth of the lens elements in a Fresnel substrate (measured on the vertical) may be between about 10 pm and 500 pm, or between about 50 μm and 250 μm.

Substrate

The substrate is generally made of an optically clear material. Examples of suitable materials include thermoplastics, polyacrylates, polymethacrylates, PMMA, PET, polycarbonate, polystyrene, thermosets and crosslinked or crosslinkable silicon-based organic and inorganic polymers such as siloxane polymers (e.g., silicones) and glass. Copolymers and blends of the abovementioned materials may also be used. The substrate may be a thermoplastic material or may be a crosslinked material. The substrate can be provided as individual sheets sized for a particular application, or as a roll intended to be cut into smaller sizes. The thickness of the substrate may vary, and may (for example) be between 20 μm and 50 mm.

In some embodiments the substrate is monolithic, meaning that the substrate is a single integrated unit and that the chemical composition of the substrate is constant throughout the unit. For example, a monolithic substrate does not have a surface that differs in composition from the bulk material. For example, a monolithic substrate prepared from PMMA does not have a region that has a different composition, such as a PMMA block copolymer integrated into the surface.

Deposition and rinse solutions

The subject coatings are prepared via a spray LbL deposition method. The spray LbL method involves alternately and repeatedly spraying a first deposition solution and a second deposition solution onto a substrate. The first and second deposition solutions each contain at least a coating material (e.g. nanoparticles or a polyelectrolyte) and a solvent, and may optionally contain other components (e.g. salts, etc.). Each repetition of application of the first and second deposition solutions creates a bilayer. The coating thickness can be adjusted, for example, by adjusting the number of bilayers that are deposited or the thickness of the nanoparticles.

After each deposition solution is applied, a rinse solution can be applied to remove excess and unbound or loosely bound coating material. In some embodiments, the rinse solution is applied after application of the first deposition solution and prior to application of the second deposition solution, and is then further applied after application of the second deposition solution and prior to the re-application of the first deposition (i.e., for preparation of additional layers). The rinse solutions comprise a solvent and may optionally contain other components such as those described below (e.g. salts, etc.).

Nanoparticles

The subject coatings are prepared using nanoparticles, and at least one of the deposition solutions comprises nanoparticles. Materials that are suitable for the nanoparticles include metal oxides, metal nitrides, metal sulfides, metals, ceramics, quantum dots, fullerenes, carbon onions, inorganic polymers, organic polymers, and hybrid materials. Examples of metal oxides include oxides of silicon, titanium, cerium, iron, chromium, copper, zinc, silver, cobalt, and the like. Specific examples of metal oxides include silicon dioxide, titanium dioxide, cerium(IV) oxide, and the like. Examples of metal nitrides include nitrides of titanium, aluminum, and the like. Specific examples of metal nitrides include titanium nitride, aluminum nitride, and the like. Examples of metals include silver, gold, copper, iron, zinc, aluminum, and the like. Inorganic polymers and hybrid polymers such as polydimethylsiloxane, polymethylhydrosiloxane and organic particles like polymethylmethacrylate and the like may also be used.

In some embodiments, the nanoparticles have an average diameter within the range 1 to 50, 40, 30, 20 or 15 nm. For example, the nanoparticles may have an average diameter that is greater than 1, 3, 5, 7, 10, 15, 20 or 30 nm, and/or less than 50, 30, 20, 15 or 10 nm. Furthermore, the polydispersity index (PDI) of the average diameter of such nanoparticles may be in the range of 0.0-2.0, wherein the theoretical limit (i.e. for monodisperse nanoparticles) is a PDI of 0.0. The PDI may also be in the range 0.01-1.5, or 0.1-1.0. For example, the polydispersity may be less than 2, 1.5, 1, 0.5, 0.3, 0.1, 0.05, or 0.01, and/or greater than 0.01, 0.05, 0.1, or 0.5.

In some embodiments the nanoparticles contain a first binding group complementary to a second binding group. By “complementary” is meant that the first binding group and the second binding group together form a binding pair. A binding pair forms a non-covalent chemical bond which may be selected from an ionic bond, a hydrogen bond, hydrophobic interaction, a Van der Waals interaction, an affinity bond (e.g. antibody-antigen bond, avidin-biotin bond, etc.), etc. The first binding group may be an ionic group, a hydrogen donor, or a hydrogen acceptor, or a precursor of any such group, wherein a precursor is a group that can be converted to an ionic group, hydrogen donor, or hydrogen acceptor, for example upon a change in environmental conditions or upon reaction with an activating agent.

In some embodiments, each nanoparticle contains a plurality of first binding groups. In some embodiments, such first binding groups are disposed on or near the surface of the nanoparticles, such that they are exposed and available to interact with second binding groups and/or salt ions when either/both are present. In some embodiments, the nanoparticles have a plurality of ionic or ionizable moieties.

Nanoparticles having shapes other than spheres may also be used to prepare similar coatings using the spray LbL methods as described herein. For example, ellipsoidal, rod-shaped, and disk-shaped nanoparticles may be used. Unless specified otherwise, the term “nanoparticles” includes non-spherical shapes.

Polyelectrolyte

In embodiments, the subject coatings are prepared using a polyelectrolyte—a material that possesses multiple ionic or ionizable functionalities. In some embodiments, the polyelectrolyte is an organic polymer or an inorganic polymer. For example, the polyelectrolyte can be a polymer having an average molecular weight greater than 100, 500, 1,000, 5,000, 10,000, 50,000 or 100,000 Da, or greater than 1 M Da. The repeating units may be of any size, from methylene oxide to larger repeat units containing one or more functional groups and heteroatoms. In some embodiments the polyelectrolyte is in nanoparticulate form, although such nanoparticulate polyelectrolytes are distinct from the nanoparticles of the bilayers.

In some embodiments, the polyelectrolyte contains a binding group which is referred to herein as a “second binding group.” The second binding group is a group that, along with a first binding group (described above with reference to the nanoparticles), forms a complementary binding pair. Accordingly, the second binding group may be an ionic group, a hydrogen donor, or a hydrogen acceptor, or a precursor of any such group. Where the first binding group is an ionic group, the second binding group is an ionic group, and the two binding groups have opposite charges, the two binding groups may be referred to as a binding pair. Where the first binding group is a hydrogen acceptor, the second binding group is a hydrogen donor, and vice versa. Examples of ionic binding pairs include positive ions such as quaternary amines and negative ions such as carboxylic acids, either of which may be used as the first or second binding groups. Other examples of ionic binding pairs are provided herein.

In some embodiments, the polyelectrolyte is a polymer, and each polyelectrolyte molecule has a plurality of second binding groups distributed along the polymer chain. In some embodiments, the polyelectrolyte is a small molecule, and each polyelectrolyte molecule has one or more second binding groups.

Examples of suitable polyelectrolytes include poly(diallyl dimethyl ammonium chloride) (PDAC), polyacrylic acid (PAA), polyacrylates, polymethacrylate, polymethylmethacrylate, poly(styrene sulfonate) (PSS), poly(vinyl alcohol) (PVA), poly(vinyl sulfonic acid), Chitosan, CMC, PAH, hyaluronic acid, polysacchardies, DNA, RNA, proteins, LPEI, BPEI, polysilicic acid, poly(3,4-ethylenedioxythiophene) (PEDOT) and combinations thereof with other polymers (e.g. PEDOT:PSS), copolymers of the abovementioned, and the like. Other examples of suitable polyelectrolytes include trimethoxysilane functionalized PAA or PAH.

In some embodiments the silane materials described in PCT/US12/25138 (the contents of which are incorporated by reference) are used. Such silane materials can be used to impart the inventive devices with resistance to heat, humidity, and other environmental factors. For example, the polyelectrolyte may be a polymer comprising repeat units of formula (I) and repeat units of formula (II)

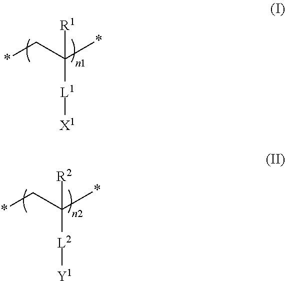

wherein, in formula (I) and formula (II): n1 and n2 are independently integers; R¹ and R² are independently selected from H and lower alkyl (e.g., methyl, ethyl, propyl, butyl, and the like); L¹ and L² are linker moieties independently selected from a bond or an alkylene, arylene, or alkenylene moiety, any of which may contain one or more heteroatoms and may be unsubstituted or substituted (e.g., carbonyl linkers, oxycarbonyl linkers, oxycarbonyloxy linkers, amino linkers, amido linkers, and the like); X¹ is an ionic moiety; and Y¹ is a crosslinkable moiety. In some such aspects, Y¹ is selected from trialkoxysilanes, triaryloxysilanes, mixed alkoxy and aryloxy silanes, and epoxy, and wherein X¹ is an amine, acrylate, or carboxylic acid.

Salts

In embodiments, the subject coatings are prepared using deposition solutions that comprise a salt. Each solution used in the LbL process may have a salt, and the identity and concentration of the salt is independently selected based on the needs of the solution and the overall process. For example, each deposition solutions may have a salt, and the rinse solution may also have a salt. The salts and salt concentrations in the deposition and rinse solutions need not be the same, although in some embodiments they are the same.

Examples of suitable salts include halide salts, e.g., chloride salts such as LiCL, NaCl, KCl, CaCl₂, MgCl₂, NH₄Cl and the like, bromide salts such as LiBr, NaBr, KBr, CaBr₂, MgBr₂, and the like, iodide salts such as Lil, NaI, KI, CaI₂, MgI₂, and the like, and fluoride salts such as CaF₂, MgF₂, LiF, NaF, KF, and the like. Further examples include sulfate salts such as Li₂SO₄, Na₂SO₄, K₂SO₄, Ag₂SO₄, (NH₄)₂SO₄, MgSO₄, BaSO₄, COSO₄, CuSO₄, ZnSO₄, SrSO₄, Al₂(SO₄)₃, and Fe₂(SO₄)₃, as well as similar nitrate salts, phosphate salts, fluorophosphate salts, and the like. Further examples include organic salts such as (CH₃)₃CCl, (C₂H₅)₃CCl, tetraethylammonium chloride, and the like. In some embodiments, mixtures of these and other salts are also suitable.

In some embodiments, the salt concentrations in the deposition solutions are selected to balance attractive and repulsive forces during the LbL deposition process, such that tightly-packed layers of nanoparticles are formed. As used herein, by a “tightly packed” (also referred to herein as “closely packed” and “densely packed”) layer of nanoparticles is meant that the nanoparticles form a substantially homogeneous monolayer with a high packing density of nanoparticles. In the context of nanospheres, the monolayer may have any of a variety of packing geometries, including a packing geometry selected from square (i.e. each sphere has four immediate neighbor spheres) and hexagonal (i.e. each sphere has six immediate neighbor spheres). In any such packing geometry, a monolayer comprises nanoparticles and void spaces between the nanoparticles, and there is a theoretical maximum packing density that occurs for a perfect hexagonal structure without spaces between particles. In the context of hexagonally packed nanospheres, then, a “tightly packed layer” is one that has a high packing density of nanospheres compared with the theoretical maximum. In some embodiments, for example, the tightly packed layer has a packing density that is greater than 80% of the theoretical maximum, or greater than 90% of the theoretical maximum, or greater than 95% of the theoretical maximum, or greater than 99% of the theoretical maximum. Such tightly packed layers may occur with minimal or no defects over a wide area, such as an area of greater than 1 μm², or greater than 10 μm², or greater than 100 μm².

In some embodiments, the salt concentration in the deposition solution can range between 1 mM and 1000 mM, or between 1 mM and 500 mM, or between or between 10 mM and 500 mM, or between 10 mM and 100 mM or between 30 mM and 80 mM. In some embodiments the salt concentration in the deposition solution is greater than 1 mM, 10 mM, 100 mM or 500 mM. In some embodiments, the salt concentration is less than 500 mM, 100 mM, 70 mM, 50 mM, or 20 mM. In some embodiments, the salt concentration in the rinse solution can range between 0 mM and 100 mM, such as between 1 and 80 mM, or between 1 and 50 mM, or between 5 and 80 mM. In some embodiments, the salt concentration in the deposition and/or rinse solutions is varied with salt identity. For example, for solutions containing TM50 silica nanoparticles, salt concentrations of NaCl ranging from about 45 mM to about 60 mM provide a window of film growth rates that are independent of salt concentration. Also for example, for solutions contains AS40 silica nanoparticles, salt concentrations of tetramethylammonium chloride ranging from about 50 mM to about 100 mM provide a window of film growth rates that are independent of salt concentration.

Solvents and other materials

In embodiments, the subject coatings are prepared using deposition solutions that comprise a solvent. Each solution used in the LbL process may have a solvent, and the identity of the solvent is independently selected based on the needs of the solution and the overall process. For example, each of the deposition solutions may have a solvent, and the rinse solution may also have a solvent. The solvent in the deposition and rinse solutions need not be the same, although in some embodiments they are the same.

In some embodiments the solvents are selected from polar protic solvents, polar aprotic solvents, and non-polar solvents. Examples of polar protic solvents include water and organic solvents such as alcohols (ethanol, methanol, etc.) and acids (formic acid, etc.). Examples of polar aprotic solvents include ethers such as tetrahydrofuran, dimethyl ether, and diethyl ether, sulfoxides such as dimethyl sulfoxide, and amides such as dimethyl formamide. Examples of non-polar solvents include alkanes such as hexane and pentane. In some embodiments, mixtures of such solvents are also suitable. For example, in some embodiments a mixture of an alcohol and water such as a 95/5 mixture of water and ethanol may be used for the deposition solutions, the rinse solution, or all three solutions. In some embodiments, water is used for the deposition solutions and the rinse solution. In some embodiments, water containing salts and other additives is used for the deposition and rinse solutions.

The deposition solutions and rinse solutions may further contain pH modifying agents. Such pH modifying agents include strong and weak acids and bases that are commonly used as buffers. For example, sodium hydroxide, hydrochloric acid, nitrogen-based compounds (e.g., ammonia, ammonium hydroxide, acetic acid, tetramethylammonium hydroxide, tetraethylammonium hydroxide), nitric acid, and the like may be used. Such compounds also provide counterions to the polyelectrolyte and nanoparticles in solution. Thus, in some embodiments, the counterion is nitrogen-based (e.g., ammonium ion, etc.). In embodiments, the nanoparticle and polyelectrolyte solutions each contain a pH modifying agent or are otherwise pH controlled. For example, in some embodiments the pH of the nanoparticle and polyelectrolyte solutions are independently selected and maintained in the range 9.5-14, or between 10-14, or between 10.7-14. In embodiments, the pH is greater than 9.5, 10, 10.7, 11, or 11.5.

In some embodiments a rinse solution is applied to the coating after each layer is deposited. The rinse solution can comprise any suitable solvent, such as mentioned above, and in some embodiments the rinse solution contains the same solvent as the deposition solutions. For example, in some embodiments the rinse solution is water, such as deionized water. The rinse solution may also contain a salt which may be the same or different from the salt(s) used in the deposition solution. The rinse solution may further contain a pH modifying agent such that the pH of the rinse solution is controlled. For example, in some embodiments the pH of the rinse solution is maintained in the range 1-7, or between 1-5, or between 1-3, or between 3-7, or between 5-7. In some embodiments the pH of the rinse solution is maintained in the range 7-14, or between 9-14, or between 11-14, or between 7-11. In embodiments, the pH is greater than 9.5, 10, 10.7, 11, or 11.5. In some embodiments, the pH is maintained between 6-8. In some embodiments, the rinse solution may be selected in a manner consistent with each deposition solution.

Methods of Preparation

Methods for preparing coatings having tightly packed nanoparticles are described in copending U.S. Provisional Patent Application Ser. No. 61/533,713, filed Sep. 12, 2011, the contents of which are incorporated by reference.

In some embodiments, the coatings are prepared via a method comprising: (a) spray depositing a bilayer directly onto a substrate, wherein the bilayer comprises a polyelectrolyte and nanoparticles having an average diameter less than 50 nm, wherein the bilayer forms a conformal coating on a textured surface of the substrate; and (b) repeating step (a) a plurality of times to form a plurality of conformal bilayers, wherein the substrate comprises an optically clear polymeric material, and wherein the average thickness of the bilayers is in the range of 75-87% of the average diameter of the nanoparticles.

The coatings described herein are prepared using a spray layer-by-layer (LbL) deposition method. The LbL spray deposition method uses at least two deposition solutions and at least one rinse solution. For the purposes of the discussion below, the LbL process is carried out using two deposition solutions—a “first deposition solution” containing nanoparticles and a “second deposition solution” containing a polyelectrolyte—as well as a single rinse solution. It will be appreciated that such discussion is not meant to be limiting, and applies to LbL processes using more than two deposition solutions, or using nanoparticles in the second deposition solution and polyelectrolytes in the first deposition solution, or using more than one rinse solution, etc.

In preparing coatings using the spray LbL method, a plurality of bilayers is prepared by alternate spray deposition of the two deposition solutions. Initial spraying of the first deposition solution provides a layer (e.g., a monolayer) of nanoparticles. Subsequent spraying of the second deposition solution provides polyelectrolyte, thereby forming a bilayer. The order of deposition may be reversed, with initial spraying being of the second deposition solution to provide a layer of polyelectrolyte, and subsequent spraying being of the first deposition solution to provide a monolayer of nanoparticles, thereby forming a bilayer. The deposition of the polyelectrolyte may result in a continuous discrete layer of polyelectrolyte (i.e., one that wholly or partially separates the nanoparticles of one bilayer from those of an adjacent bilayer) or may result in polyelectrolyte located substantially within the interstitial spaces between nanoparticles.

Because of the inclusion of salts, the deposition solutions remain stable throughout the spraying portion of the deposition process. By “stable” is meant that substantially no flocculation of the nanoparticles occurs. In a stable solution the nanoparticles tend to keep a minimum average distance away from other nanoparticles, wherein the minimum distance is sufficient to avoid flocculation. Avoidance of flocculation during deposition simplifies solution handling practices (e.g. by avoiding clogging of spray nozzles, etc.), and furthermore helps to ensure that uniform close-packed nanoparticle monolayers are formed.

In some embodiments, then, the zeta potential of the nanoparticles in the first deposition solution is large enough such that the solution is stable prior to and during the time that the first deposition solution of nanoparticles is sprayed onto the surface. Suitable zeta potentials include, for example, greater than about 5, 10, 15, 20, 30 40 or 50 mV. A variety of factors can be modified to obtain a desired zeta potential. For example, zeta potentials can be modified by selection of the concentration and identity of salts present in the solution, the pH of the solution, and the like. In some embodiments, the zeta potential is invariant with pH, meaning that the zeta potential plateaus with respect to pH.

Formation of a close packed monolayer of nanoparticles in the subject films can be conceptualized as a two-dimensional flocculation. Accordingly, the deposition solution transitions from stable to unstable at a point during the deposition process. By “unstable” is meant that the nanoparticles are able to condense and form a close packed array. In an unstable solution, the nanoparticles do not necessarily maintain a minimum distance that avoids flocculation.

In some embodiments, the zeta potential of the nanoparticles in the first deposition solution decreases after it has reached the surface upon which a coating is being formed. The decrease is sufficient to convert the solution from stable to unstable. Suitable zeta potentials include, for example, less than about 15, 10, or 5 mV. In some embodiments, the effect of the surface charge, as measured by zeta potential, is shielded due to the presence of salt. Salt induced shielding is a well-known concept in the art of colloidal solutions.

The foregoing discussion of zeta potentials is provided without intending to limit the invention by theory. In particular, actual zeta potentials may or may not conform to the above-described theory, and may or may not be measurable with known techniques.

Regardless of whether or not the zeta potentials may be measured, certain physical manifestations of the stability/instability of the solutions and coatings described herein will be apparent. For example, deposition solution stability can be observed due to the lack of flocculation that occurs. Instability of the solutions once applied to the surface can be observed via the formation of close packed nanoparticle arrays. These and other observations may be used to confirm the stability/instability and the transition there-between of the subject solutions.

The ionic strength and pH of the deposition solutions are generally maintained such that the solutions are stable (i.e. no flocculation occurs). In some such embodiments the solutions are marginally stable—i.e. a slight change in pH or ionic strength causes the solutions to become unstable (as evidenced by the occurrence of flocculation). In such a stable solution the nanoparticles will be able to approach one another as closely as possible without adhering and causing flocculation.

By controlling the pH and ionic strength of the deposition solutions, the zeta potential of the nanoparticles can be maximized. In some embodiments, the pH is maintained such that the zeta potential is invariant with pH (i.e. the zeta potential is at a plateau with respect to pH). Furthermore, the ionic strength is increased (e.g. using dissolved salts) to a level that allows for some shielding of the charges at the nanoparticle surfaces. At such pH and ionic strength levels, the deposition solution is stable, yet the nanoparticles bind tightly to the underlying surface. Methods for determining the optimum pH and ionic strength levels include, for example, salting out a solution and then operating just under the observed salt concentration. As described/used herein, altering (e.g., maximizing) zeta potential is not intended to be limited to charge density on the surface of the particles, but also the effect of that charge density over distances away from the surface of the particles (i.e. shortening or lengthening Debye lengths).

With the deposition of each bilayer, the coating grows in thickness. Thus, it is possible to graph the coating thickness (e.g. an averaged value as determined via optical or physical measurements) as a function of the number of bilayers deposited. The coating growth rate may be defined as the slope of such a graph. In some embodiments, the coating growth rate is within 10%, or 5%, or 3% of the ideal value, wherein the ideal value is 81% of the diameter of the nanoparticles (and is calculated assuming that the nanoparticles are uniform, rigid spheres and that they form perfect three-dimensional close packed arrays, with minimal contribution due to the presence of the polyelectrolyte). Thus, for the subject coatings, the average thickness of each bilayer is less than the average diameter of the nanoparticles used in the bilayer. In some embodiments, the average thickness of each bilayer is in the range of 75-87% of the average diameter of the nanoparticles, or in the range of 78-83%, or in the range of 79-82%. In some embodiments, the average thickness of each bilayer is 81% of the average diameter of the nanoparticles.

Desired bilayer thicknesses can be obtained by selecting nanoparticles of appropriate size. In some instances the selection of an appropriate combination of differently sized nanoparticles may be used to further tune the growth rate and/or properties of the resulting coatings.

Coatings may be prepared using two or more types of bilayers, wherein the types of bilayers differ, for example, in the materials used. For example, a coating may be made from two types of bilayers, wherein one bilayer is formed from PDAC and SiO₂ nanoparticles, and the other bilayer is formed from PDAC and TiO₂ nanoparticles. The two types of bilayers may be alternated, or may be deposited in groups. Such arrangements may be used to prepare coatings having desired optical properties such as Bragg reflectors.

The depositions solutions are prepared and applied as a spray to the surface in order to form bilayers. Rinse solution is applied after each bilayer and optionally after each layer forming the bilayers. After each application of a solution, whether of a rinse or deposition solution, the methods comprise an optional step of removing excess liquid from the surface. Such removal may be carried out, for example, using a stream of air or the like.

In embodiments, each spraying (i.e., each spraying of the nanoparticle solution, the polyelectrolyte solution, and the rinse solution) has a duration of spraying between 1-60 seconds, or between 5-45 seconds, or between 5-30 seconds. In embodiments, each spraying has a duration less than or equal to 60, 45, 30, 20, or 15 sec, or greater than or equal to 1, 3, 5, 10, 15, or 30 seconds.

In some embodiments, the methods for preparation of the inventive optical elements do not include a thermal treatment step. Thus, the substrate is not heated prior to coating for the purpose of modifying the composition of the substrate. For example, the substrate is not heated in the presence of an adhesion promoter compound such as a block copolymer. In some embodiments, the substrate is maintained at room temperature, or maintained below a selected temperature such as 50° C., or 40° C., or 30° C., prior to applying the coating.

Coating properties

The subject devices comprise optical elements that are multi-layer optical films, and therefore modify an optical property of the substrate or impart an optical property to the substrate. The films comprise a plurality of bilayers, wherein each bilayer comprises nanoparticles and a polyelectrolyte. As used herein, the terms “film” and “coating” are used synonymously.

The films are prepared using nanoparticles, and in some embodiments the nanoparticles are spherical. Accordingly, the films are porous due to the interstitial spaces that are present between nanoparticles. Such interstitial spaces may be partially filled with polyelectrolyte, with the remaining space occupied by a gas or liquid such as air, nitrogen, water, etc. In some embodiments the pores are open (i.e., connected and forming a network of pores). The size of the pores varies with the geometry and composition of the nanoparticles and other film components, and in some embodiments is on the order of nanometers. Such pores may be referred to herein as nanopores. For example, the nanoparticles have a diameter less than about 50 nm, and the nanopores within a film prepared using such nanoparticles also have a diameter (i.e., a greatest dimension) of less than about 50 nm.

In some embodiments, the coatings are anti-reflection coatings. Such coatings reduce the amount of reflected incident light by at least about 4%, 5%, 10%, 15%, 20%, 25%, 35%, 50%, or 75% (wherein such reductions are a percentage of the amount of reflected light in the absence of the coating). The anti-reflective coatings may be tailored for anti-reflection in a specific wavelength or range of wavelengths. For example, the anti-reflective coatings may be designed for optimal anti-reflective performance in the UV spectrum, or in the IR spectrum, or in the visible light spectrum, or a combination thereof. Tailoring of this sort is accomplished by selecting appropriate thicknesses of bilayers and is within the skill in the art.

For example, an unmodified Fresnel lens substrate (i.e., one not containing a coating as described herein) may have a reflectivity of 5% of incident visible light at the smooth surface and 5% of incident visible light at the textured surface. In contrast, the same Fresnel lens coating according to the invention may have a reflectivity of 4.75%, corresponding to a reduction of reflected light of 5% (or 4.5%, corresponding to a reduction of reflected light of 10%, etc.) at each surface containing the coating.

In some embodiments, the coatings are Bragg reflectors and provide optical waveguide properties to the substrate.

The coatings cause minimal (e.g., substantially zero, such as less than 10, 5, 3, 1, 0.1, or 0.01%) scattering of incident light. This is achieved by using nanoparticles that are used are small enough to avoid scattering—e.g., less than 50 nm in diameter as described herein. Thus, the coatings have minimal haze. For example, the coatings have a haze that is less than 0.5%, or less than 0.4%, or less than 0.3%, or less than 0.2%, or less than 0.1%, or less than 0.05%. Selection of appropriate polyelectrolyte can also reduce haze (e.g., using lower molecular weight polyelectrolyte, such as 20,000 Da or below, when larger nanoparticles are used, such as 25 nm diameter or greater).

The films are conformally disposed on a surface (i.e., a smooth surface, a textured surface, or both) of the substrate. Furthermore, in some embodiments, the coatings are uniform across the substrate, whether on a textured or smooth surface. By “uniform” is meant that the thickness of the coatings do not vary by more than a factor of about 2, 1.8, 1.5, 1.3, or 1.1 over the coated area (with allowances for localized defects).

The thickness of the coatings may be selected based on the intended application and desired properties. For example, the thickness may be between about 50 nm and about 600 nm. For example, the thickness may be between 100 nm and 150 nm, such as 120 nm, or 125 nm, or 130 nm, or 135 nm, or 140 nm, or 145 nm, or 150 nm. As indicated above, the thickness of each bilayer is between about 75-87% of the thickness of the nanoparticles used in the deposition.

The refractive index of a film as prepared herein can be tailored by selecting appropriate materials for film preparation. In embodiments, the refractive index is selected to be lower than 1.4, or lower than 1.3, or lower than 1.2.

In some embodiments, the film is self-adherent to the substrate, wherein the optical elements do not include an adhesion promoter between the substrate and the film. Thus, the film directly contacts that substrate (i.e., the film is directly disposed on the substrate, without an adhesion promoter intermediate layer). Even without an adhesion promoter, the films are sufficiently adherent to the substrate such that the optical element is robust and suitable for commercial uses. These embodiments advantageously avoid the need for adhesion promoters, such as the the PMMA-PAA block copolymers used in U.S. Patent Application Publication number 20120082831.

The inventive optical elements can be integrated into any system where the properties of the optical element are desirable. For example, an optical element can be integrated into a concentrating solar energy production system.

It is to be understood that while the invention has been described in conjunction with examples of specific embodiments thereof, that the foregoing description and the examples that follow are intended to illustrate and not limit the scope of the invention. It will be understood by those skilled in the art that various changes may be made and equivalents may be substituted without departing from the scope of the invention, and further that other aspects, advantages and modifications will be apparent to those skilled in the art to which the invention pertains. The pertinent parts of all publications mentioned herein are incorporated by reference.

### EXAMPLE 1

### Solution Preparation

100-200k MW polydiallyldimethylammonium chloride (PDAC, 20wt % solution) and tetramethyl ammonium hydroxide (TMAOH) were purchased from Sigma-Aldrich. 16.17 g of PDAC was added to a plastic cup, containing about 100 ml of deionized water. A stir bar was added and mixed using a stir plate, set to 200 rpm for 5 minutes. PDAC solution was transferred to a larger container, until 16.2 g of PDAC was combined with 983.8 g of deionized water, for a total weight of 1000.0 g. The solution was then stirred for 30 minutes at 700 rpm on a stir plate. Finally the pH of the solution was adjusted to 10.0 by adding TMAOH.

Silicon dioxide nanoparticle dispersions (AS-40, Ludox™), tetraethyl ammonium hydroxide (TEAOH) and tetraethylammonium chloride (TEACl) were purchased from Sigma-Aldrich. 1000 g of deionized water was added to a plastic container being stirred at 500 rpm on a stir plate. TEAOH was added to the water until a pH=12.0 was achieved. 8.29 g of TEACl was then added to the water until all the salt was dissolved. 25.0 g of AS-40 was then added to the plastic container and left to stir for 5 minutes.

Rinse water was prepared by adding TMAOH to the deionized water until a pH of 10.0 was achieved.

### EXAMPLE 2

### Layer-by-Layer Deposition of Low Index Optical Films

Low index optical films were deposited onto 2″×2″ PMMA substrates using a deposition system (modeled after the systems described in U.S. Patent Application Publication No. US 2010/0003499 to Krogman et al., as well as Krogman et al., Automated Process for Improved Uniformity and Versatility of Layer-by-Layer Deposition, Langmuir 2007, 23, 3137-3141). The PMMA substrates included both flat (smooth) sides and Fresnel lens (textured) sides. In both cases only a single side is coated. For the case of the Fresnel lens, the textured side was coated. Six (6) PDAC-AS40 bilayers (or cycles of PDAC-rinse-AS40-rinse applied to the surface) were deposited for the formation of a low index film (LO). The film thickness was measured to be 90 nm and refractive index of 1.26 by optically modeling (TFCalc) the reflectometry data of the flat substrate, measured on a UV-Vis spectrophotometer (Shimadzu). Corresponding transmission measurements indicated an absolute increase in transmission of 4.2% at 550 nm (from 90.0% for PMMA reference to 94.2%), corresponding to a percentage increase of 4.7%.

### EXAMPLE 3

### Layer-by-Layer Deposition of Low Index Optical Films on Textured Surfaces

Low index optical films, described in Example 2, were deposited on 2″×2″ PMMA Fresnel lens substrates using a deposition system (modeled after the systems described in U.S. Patent Application Publication No. US 2010/0003499 to Krogman et al., as well as Krogman et al., Automated Process for Improved Uniformity and Versatility of Layer-by-Layer Deposition, Langmuir 2007, 23, 3137-3141). In each case excess residual rinse water on the surface and in the grooves was removed by a flow of air.

### EXAMPLE 4

### Layer-by-Layer Deposition of Low Index Optical Films on Large Area Fresnel Lens

Optical films are deposited on 14″×14 PMMA Fresnel lens array substrates (each lens being about 190 mm×190 mm) using a deposition system (modeled after the systems described in U.S. Patent Application Publication No. US 2010/0003499 to Krogman et al., as well as Krogman et al., Automated Process for Improved Uniformity and Versatility of Layer-by-Layer Deposition, Langmuir 2007, 23, 3137-3141).

### EXAMPLE 5

### Layer by Layer Deposition of Bragg Reflector on Large Area Fresnel Lens

Optical films are deposited on 14″×14″ PMMA Fresnel lens array substrates (each lens being about 190 mm×190 mm) using a deposition system (modeled after the systems described in U.S. Patent Application Publication No. US 2010/0003499 to Krogman et al., as well as Krogman et al., Automated Process for Improved Uniformity and Versatility of Layer-by-Layer Deposition, Langmuir 2007, 23, 3137-3141). Titanium dioxide nanoparticle dispersions (X500) are purchased from Titan PE. 1000 g of X500 are added to an empty plastic container. A stir bar is added to the container and stirred at 500 rpm. 8.29 g of TEACl is then added to 10 ml of deionized water in a separate 20 ml glass scintillation vial. The vial is closed tightly with a screw cap and shaken until the salt was dissolved. Using a transfer pipette, the TEACl solution is added to X500 solution and stirred for an additional 5 minutes. 11 PDAC-X500 bilayers (or cycles of PDAC-rinse-X500-rinse applied to the glass surface) are deposited for the formation of a high index film (HI). 7 PDAC-AS40 bilayers (or cycles of PDAC-rinse-AS40-rinse applied to the glass surface) are deposited for the formation of a low index film (LO). These numbers of bilayers are selected to create quarter wavelength optical thickness (QWOT) stacks for a 550 nm wavelength design. A 7-film architecture consisting of glass-HI-LO-HI-LO-HI-LO-HI is used to create the optical dichroic mirror.

### EXAMPLE 6

### Increase in Transmission for Concentrating Photovoltaic Applications

Optical transmittance measurements were weighted relative to different photovoltaic absorbing spectrum. The low index film described in Example 2 demonstrates an increase in optical flux density over the wavelengths 280-2600 nm compared with the bare PMMA substrate (from 744 W/m² to 771W/m²) and an increase in spectral photon irradiance from 8.32e39 [m⁻² s⁻¹ nm⁻¹] to 8.63e39 [m⁻² s⁻¹ nm⁻¹] for crystalline silicon (300-1120 nm).

1. A method for forming an optical element comprising bilayers, the method comprising step(s):
(a) alternately spraying polyelectrolyte and nanoparticle solutions onto a textured surface of a substrate, thereby depositing on the surface corresponding polyelectrolytes and nanoparticles and forming on the surface, in a layer-by-layer fashion, a plurality of nanoporous bilayers comprising polyelectrolyte and nanoparticle layers, wherein the polyelectrolyte and nanoparticle solutions each have a pH above 9.5.

2. The method of claim 1, wherein the average thickness of each bilayer is less than the average diameter of the nanoparticles.

3. The method of claim 1, wherein the average thickness of each bilayer is in the range of 75-87% of the average diameter of the nanoparticles.

4. The method of claim 1, wherein the pH of the nanoparticle solution is above 10.7.

5. The method of claim 1, further comprising:
(b) spraying a rinse solution onto the surface after spraying each polyelectrolyte solution and after spraying each nanoparticle solution.

6. The method of claim 1, wherein step (a) further comprises spraying a rinse solution onto the surface after spraying each polyelectrolyte solution and after spraying each nanoparticle solution,
wherein the polyelectrolyte solution, the nanoparticle solution, and the rinse solution each comprise salts sufficient to ensure that the thickness of the plurality of nanoporous bilayers does not vary by more than a factor of two over the substrate.

7. The method of claim 1, wherein step (a) further comprises spraying a rinse solution onto the surface after spraying each polyelectrolyte solution and after spraying each nanoparticle solution,
wherein the average thickness of each bilayer is in the range of 75-87% of the average diameter of the nanoparticles.

8. The method of claim 1, wherein the substrate comprises a smooth surface opposite the textured surface, and wherein the spraying is only on the textured surface such that the plurality of nanoporous bilayers is formed only on the textured surface.

9. The method of claim 1, wherein the plurality of nanoporous bilayers comprises at least 5 bilayers.

10. The method of claim 1, wherein:
the plurality of nanoporous bilayers comprises at least 5 bilayers;
the substrate comprises a smooth surface opposite the textured surface; and
the spraying is only on the textured surface such that the plurality of nanoporous bilayers is formed only on the textured surface.

11. The method of claim 1, wherein the nanoparticle solution comprises a plurality of different nanoparticle solutions comprising corresponding different nanoparticles, such that the bilayers comprise a plurality of corresponding different nanoparticle layers.

12. The method of claim 1, wherein ridges of a Fresnel lens provide the textured surface.

13. The method of claim 1, wherein ridges of a Fresnel lens provide the textured surface, and wherein the thickness of the plurality of nanoporous bilayers does not vary by more than a factor of two over the substrate.

14. The method of claim 1, wherein the nanoparticles have an average diameter less than 50 nm.

15. The method of claim 1, wherein the substrate is maintained below 40° C. during and immediately prior to the spraying.

16. The method of claim 1, further comprising:
(b) spraying a rinse solution onto the surface after spraying each polyelectrolyte solution and after spraying each nanoparticle solution,
wherein ridges of a Fresnel lens provide the textured surface.

17. The method of claim 1, wherein step (a) further comprises spraying a rinse solution onto the surface after spraying each polyelectrolyte solution and after spraying each nanoparticle solution,
wherein the nanoparticle, polyelectrolyte, and rinse solutions comprise salts sufficient to ensure that the thickness of the plurality of nanoporous bilayers does not vary by more than a factor of two over the substrate, and wherein the salts alter the zeta potential of the nanoparticles sufficiently to ensure that the average thickness of each bilayer is in the range of 75-87% of the average diameter of the nanoparticles.

18. The method of claim 1, wherein the plurality of nanoporous bilayers causes substantially zero scattering of light incident on the substrate.

19. The method of claim 1, wherein at least one of the polyelectrolyte and nanoparticle solutions comprise a nitrogen base-based counterion.

20. The method of claim 1, wherein each spraying has a duration of 10-30 seconds.
